(19) United States
(12) Patent Application Publication
(10) Pub. No.: US 2020/0070646 A1
(43) Pub. Date: Mar. 5, 2020

(54) FUEL TANK LID UNIT

(71) Applicant: AISAN KOGYO KABUSHIKI KAISHA, Obu-shi, Aichi (JP)

(72) Inventors: Masaki IKEYA, Obu-shi (JP); Yoichi KAWAKITA, Obu-shi, Aichi (JP)

(21) Appl. No.: 16/468,850

(22) PCT Filed: Nov. 21, 2017
(86) PCT No.: PCT/JP2017/041888

§ 371 Date: Jun. 12, 2019

(30) Foreign Application Priority Data
Dec. 13, 2016 (JP) 2016-241579

(51) Int. Cl. B60K 15/03; H02K 5/10

(52) U.S. Cl. CPC B60K 15/03; H02K 5/10; B60K 2015/0777; B60K 2015/03447; B60K 2015/03453; B60K 2015/0319

(57) ABSTRACT

A fuel tank lid unit includes a tank lid, an accommodation unit, and an inner terminal. The tank lid closes an opening at an upper part of a fuel tank. The accommodation unit is provided at an upper part of the tank lid, and accommodates an electronic circuit in therein. The inner terminal penetrates the tank lid and connects the electronic circuit and an electronic component inside the fuel tank. The accommodation unit includes a communication opening communicating internal and external spaces. The internal space in the accommodation unit includes a first region where the electronic circuit is arranged and a second region provided below the first region and surrounding the inner terminal. In a plan view of the accommodation unit, an area of the second region is smaller than that of the first region. Further, a communication opening is provided below a first region-side end of the second region.

### TECHNICAL FIELD

The present application claims priority to Japanese Patent Application No. 2016-241579 filed on Dec. 13, 2016. The entire contents thereof are hereby incorporated by reference into the present application. The disclosure herein relates to a fuel tank lid unit used as a lid for a fuel tank.

### BACKGROUND ART

Japanese Patent Application No. 2001-99029 describes a technique for accommodating an electronic circuit, which is configured to drive a pump in a fuel tank, in an accommodation unit (circuit casing) mounted on a lid of the fuel tank. The pump and the electronic circuit are connected by an inner terminal (lead wire). The inner terminal extends from inside of the fuel tank, passes through a tank lid (mounting member) closing an opening of the fuel tank, and extends into the accommodation unit in which the electronic circuit is accommodated. Hereinbelow, Japanese Patent Application No. 2001-99029 will be termed Patent Document 1.

### SUMMARY OF INVENTION

Insides of the fuel tank and the accommodation unit are separated by the tank lid in Patent Document 1. However, since the pump in the fuel tank and the electronic circuit in the accommodation unit are connected by the inner terminal passing through the tank lid, vaporized fuel that had vaporized in the fuel tank might enter the accommodation unit through an interface between the tank lid and the inner terminal. If the vaporized fuel contacts the electronic circuit, characteristics of the electronic circuit might be deteriorated. A technique that suppresses such a contact between vaporized fuel and an electronic circuit is in necessary. The disclosure herein discloses a technique that suppresses contact between vaporized fuel and an electronic circuit in a fuel tank lid unit comprising an accommodation unit that accommodates the electronic circuit.

A fuel tank lid unit disclosed herein may comprise a tank lid, an accommodation unit, and an inner terminal. The tank lid may close an opening at an upper part of a fuel tank. The accommodation unit may be provided on the tank lid and have an electronic circuit accommodated in an internal space thereof. The inner terminal may penetrate the tank lid and connect the electronic circuit accommodated in the internal space and an electronic component inside the fuel tank. The accommodation unit may comprise a communication opening communicating the internal space and an external space. Further, the internal space of the accommodation unit may comprise a first region and a second region provided below the first region. The electronic circuit may be arranged in the first region. The second region may surround the inner terminal. In a plan view of the accommodation unit, an area of the second region may be smaller than an area of the first region. Further, the communication opening may be provided below an end of the second region on a first region side.

In the above fuel tank lid unit, the internal space of the accommodation unit in which the electronic circuit is accommodated is divided into the first region and the second region. The inner terminal extends from within the fuel tank, passes through the tank lid, the second region, and the first region, and reach the electronic circuit. The second region is a part of the internal space of the accommodation unit and surrounds the inner terminal. The inner terminal is exposed to the internal space of the accommodation unit at a bottom of the second region. Since specific gravity of vaporized fuel is higher than specific gravity of air, vaporized fuel that had entered the accommodation unit from the fuel tank along the inner terminal accumulates in the second region. That is, the above fuel tank lid unit allows the vaporized fuel in the fuel tank to enter the accommodation unit. However, the above fuel tank lid unit accumulates the vaporized fuel, which had entered the accommodation unit, in a limited range (the second region) within the internal space, and suppresses the vaporized fuel from contacting the electronic circuit arranged in the first region. Further, in the above fuel tank lid unit, the communication opening communicating inside and outside of the accommodation unit is provided below the end of the second region on the first region side (that is, an upper end of the second region). The vaporized fuel accumulating in the second region is discharged from the communication opening.

### BRIEF DESCRIPTION OF DRAWINGS

FIG. 1 shows a cross-sectional view of a fuel tank lid unit, showing an overall configuration thereof;

FIG. 2 shows a plan view of the fuel tank lid unit, showing the overall configuration thereof;

FIG. 3 shows a cross-sectional view of a fuel tank lid unit according to a first embodiment;

FIG. 4 shows a plan view of the fuel tank lid unit according to the first embodiment;

FIG. 5 shows a plan view of a fuel tank lid unit according to a second embodiment;

FIG. 6 shows a cross-sectional view of a fuel tank lid unit according to a third embodiment;

FIG. 7 shows a cross-sectional view of a fuel tank lid unit according to a fourth embodiment;

FIG. 8 shows a cross-sectional view of a fuel tank lid unit according to a fifth embodiment;

FIG. 9 shows a cross-sectional view of a fuel tank lid unit according to a sixth embodiment;

FIG. 10 shows a cross-sectional view of a fuel tank lid unit according to a seventh embodiment;

FIG. 11 shows a cross-sectional view of a fuel tank lid unit according to an eighth embodiment;

FIG. 12 shows a cross-sectional view of a fuel tank lid unit according to a ninth embodiment; and

FIG. 13 shows a plan view of the fuel tank lid unit according to the ninth embodiment.

### DESCRIPTION OF EMBODIMENTS

Some of the features characteristic to a fuel tank lid unit disclosed herein will be listed below. It should be noted that the respective technical elements are independent of one another, and are useful solely or in combinations. In the disclosure herein, expressions such as “above”, “upper”, and “upward” mean upper side in a direction of gravity, and expressions such as “below”, “lower”, and “downward” mean a lower side in the direction of gravity.

A fuel tank lid unit may be arranged at an upper part of a fuel tank, and may close an opening at the upper part of the fuel tank. The fuel tank lid unit may comprise a tank lid closing the opening at the upper part of the fuel tank and an accommodation unit provided on the tank lid. The accommodation unit may accommodate an electronic circuit. The tank lid may be constituted of resin. The accommodation unit may also be constituted of resin. An entirety of the accommodation unit may be constituted of resin, or a part thereof excluding an upper lid of the accommodation unit may be constituted of resin. The upper lid may be constituted of resin that is same as the material of the other part of the accommodation unit or may be constituted of resin that is different from the material of the other part of the accommodation unit, or may be constituted of a material other than resin, such as metal. The tank lid and the accommodation unit may be integrated, or may be separately provided. That is, the tank lid and the accommodation unit may be an integrated and inseparable object which is integrally formed by injection molding or the like, or may be independent and separable parts. A bottom of the accommodation unit may serve as the tank lid. Alternatively, the accommodation unit may be provided with a bottom that is separated from the tank lid. In this case, a gap communicating with an external space may be provided between the bottom of the accommodation unit and the tank lid. Even in the case where the gap is provided between the bottom of the accommodation unit and the tank lid, the bottom of the accommodation unit and the tank lid may be connected (or integrated) at a portion where an inner terminal extends.

The fuel tank lid unit may comprise the inner terminal extending from an internal space of the accommodation unit into inside of the fuel tank. The inner terminal may connect the electronic circuit in the accommodation unit and an electronic component inside the fuel tank. The electronic circuit in the accommodation unit may be a control circuit configured to control actuation of the electronic component in the fuel tank. A fuel pump configured to feed fuel to an engine may be exemplified as the electronic component in the fuel tank.

The internal space of the accommodation unit may comprise a first region and a second region. That is, the internal space of the accommodation unit may be divided into the first region and the second region. The electronic circuit may be arranged in the first region. The second region may be provided below the first region. In this case, the inner terminal may extend from within the fuel tank, pass through the tank lid (the tank lid and the bottom of the accommodation unit), reach inside of the accommodation unit, pass through the second region and the first region, and extend up to the electronic circuit. The second region may surround the inner terminal. In other words, a portion of the inner terminal that passes through the tank lid may be covered by the material constituting the tank lid, and the inner terminal may be exposed to space in the first and second regions. The inner terminal is exposed to the space at a lower end of the second region.

The second region may be smaller than the first region. Specifically, in a plan view of the accommodation unit, an area of the second region may be smaller than an area of the first region. The second region may be a recess extending from a part of the bottom of the accommodation unit toward the tank lid. In this case, inside of the recess is the second region, and an upper end of the recess is a boundary between the first region and the second region. Since the recess is provided in a part of the bottom, the area of the second region is smaller than the area of the first region in the plan view. Further, the second region may be defined by a wall extending upward (toward an electronic circuit side) from the bottom of the accommodation unit. In this case, a range surrounded by the wall is the second region, and an upper end of the wall is the boundary between the first region and the second region. In this case as well, the area of the second region is smaller than the area of the first region in the plan view. The second region may be formed by providing the recess in a part of the bottom of the accommodation unit and extending the wall upward from the bottom of the accommodation unit.

The accommodation unit may comprise a communication opening communicating the internal space and an external space. The communication opening may be provided below an end of the second region on a first region side. That is, the communication opening may be provided below the boundary between the first region and the second region. The communication opening may be provided in a lateral part (lateral surface) of the accommodation unit or may be provided in the bottom (bottom surface) of the accommodation unit, so long as it is below the boundary between the first region and the second region. In the case where the communication opening is provided in a lateral part of the accommodation unit, the communication opening may be provided on a lateral part that defines the second region. In this case, an opening of the communication opening on an internal space side is located in the second region. Due to this, the communication opening can be said as being provided in the second region. Further, the communication opening may be provided in a lateral part that does not define the second region. The communication opening and the second region may be connected by providing the communication opening in the lateral part that does not define the second region and providing a passage (groove) extending to the communication opening in the bottom of the accommodation unit.

In the case where the communication opening is provided in the bottom of the accommodation unit, an opening of the communication opening on an external space side may face a gap provided between the bottom of the accommodation unit and the tank lid. Further, in the case where the communication opening is provided in the bottom of the accommodation unit, the bottom of the accommodation unit may be inclined downward toward the communication opening. Even in the case where the gap is provided between the bottom of the accommodation unit and the tank lid, the opening of the communication opening on the external space side may face a portion other than the gap.

In the fuel tank lid unit disclosed herein, the inner terminal is exposed to the internal space of the accommodation unit in the second region. Due to this, the vaporized fuel that had entered the accommodation unit from the fuel tank along the inner terminal accumulates in the second region. The vaporized fuel accumulates in a specific space (the second region) within the accommodation unit. Since the vaporized fuel has a higher specific gravity than air, it accumulates from a bottom of the second region. Due to this, the vaporized fuel does not flow to a vicinity of the electronic circuit arranged in the first region, which is above the second region. Contact between the electronic circuit and the vaporized fuel is suppressed, and the electronic circuit can be suppressed from becoming deteriorated.

### Embodiments

### First Embodiment

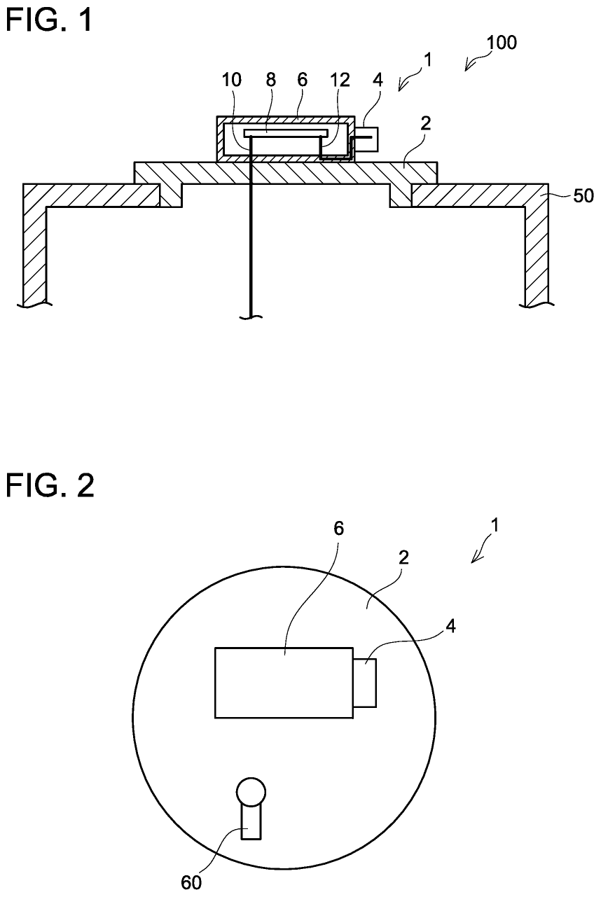

A fuel tank lid unit 1 will be described with reference to FIGS. 1 to 4. As shown in FIG. 1, the fuel tank lid unit 1 constitutes a part of a fuel supply device 100. The fuel supply device 100 is provided with a fuel tank 50 and the fuel tank lid unit 1. A fuel pump (not shown) configured to feed out fuel to an engine is arranged inside the fuel tank 50. The fuel tank lid unit 1 comprises a tank lid 2 and an accommodation unit 6. The tank lid 2 closes an opening provided at an upper part of the fuel tank 50. The accommodation unit 6 is arranged on a part of the tank lid 2. An electronic circuit 8 configured to control the fuel pump is arranged inside the accommodation unit 6.

An inner terminal 10 and an external terminal 12 are connected to the electronic circuit 8. The inner terminal 10 connects the fuel pump and the electronic circuit 8. The inner terminal 10 penetrates the tank lid 2 and extends into the fuel tank 50 from inside of the accommodation unit 6. The external terminal 12 connects an external terminal unit (not shown) and the electronic circuit 8. The external terminal 12 extends within a wall of the accommodation unit 6 and extends to a connector 4 to which the external terminal unit is connected. As shown in FIG. 2, the tank lid 2 is a circular plate, and a discharge outlet 60 for discharging the fuel fed out from the fuel tank 50 is provided on the tank lid 2.

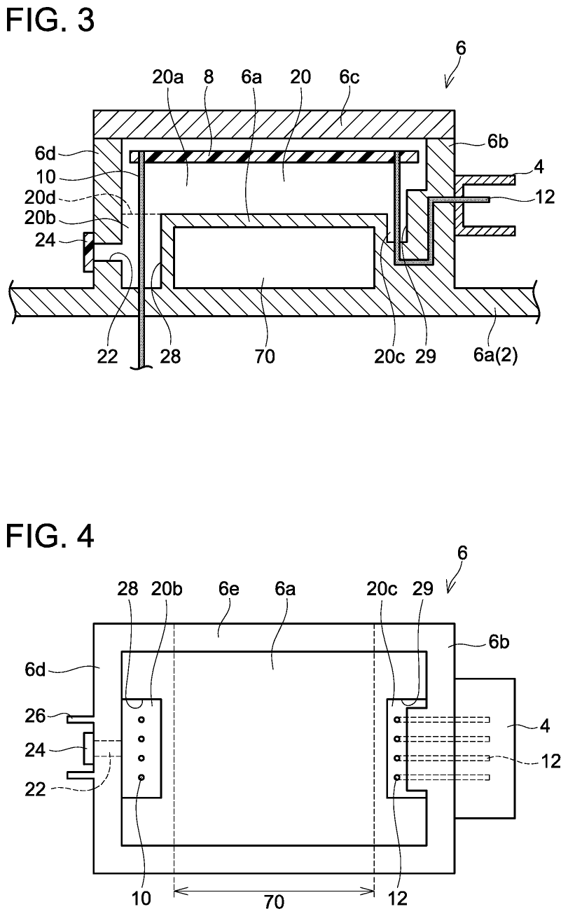

A structure inside the accommodation unit 6 will be described with reference to FIGS. 3 and 4. As shown in FIG. 3, the accommodation unit 6 includes a bottom 6a, lateral parts 6b, 6d, and an upper lid 6c, and has a substantially rectangular outer shape. Further, the accommodation unit 6 is integrated with the tank lid 2. Specifically, parts of the tank lid 2 extend upward to configure the lateral parts 6b, 6d. A gap 70 is provided between the bottom 6a and the tank lid 2. A part of the tank lid 2 serves as a part of the bottom 6a. The tank lid 2, the bottom 6a, and the lateral parts 6b, 6d are integrated, and are thus one component. The tank lid 2, the bottom 6a, and the lateral parts 6b, 6d are constituted of resin. The upper lid 6c is a separate component from the lateral parts 6b, 6d, and is fixed to the lateral parts 6b, 6d. The upper lid 6c is constituted of metal. The lateral part 6b is provided at a position opposing the lateral part 6d. The connector 4 is fixed to an outer surface of the lateral part 6b, and a waterproof film 24 is fixed to an outer surface of the lateral part 6d. That is, the connector 4 and the waterproof film 24 are respectively provided on lateral surfaces (the lateral parts) opposing each other. The waterproof film 24 will be described later.

An internal space 20 is provided inside the accommodation unit 6. The electronic circuit 8 is arranged in the internal space 20. The electronic circuit 8 is arranged at an upper portion in the internal space 20. The inner terminal 10 and the external terminal 12 are connected to the electronic circuit 8. The inner terminal 10 extends in an up-down direction within the internal space 20, penetrates the tank lid 2, and reaches inside of the fuel tank 50 (also see FIG. 1). The external terminal 12 extends in the up-down direction within the internal space 20, and reaches the bottom 6a. The external terminal 12 passes through the bottom 6a and the lateral part 6b, and extends to the connector 4. The gap 70 is provided between the bottom 6a and the tank lid 2. The gap 70 extends from one end of the accommodation unit 6 to another end thereof along a direction in which the lateral parts 6b, 6d extend (also see FIG. 4). Due to this, external air can flow through the gap 70.

The bottom 6a is provided with recesses 28, 29. The internal space 20 is divided into a first region 20a, a second region 20b, and a third region 20c by the recesses 28, 29. The first region 20a is a space between the bottom 6a and the upper lid 6c, and more specifically, it is a range from the upper lid 6c to a surface of a portion of the bottom 6a where the recesses 28, 29 are not provided. The second region 20b is inside of the recess 28, and is a range from the surface of the portion of the bottom 6a where the recesses 28, 29 are not provided to a bottom of the recess 28. The third region 20c is inside of the recess 29, and is a range from the surface of the portion of the bottom 6a where the recesses 28, 29 are not provided to a bottom of the recess 29. In FIG. 3, a boundary between the first region 20a and the second region 20b is indicated by a broken line 20d (hereinbelow termed a boundary 20d). The inner terminal 10 passes through the first region 20a and the second region 20b, and reaches the tank lid 2 (the bottom of the recess 28). The external terminal 12 passes through the first region 20a and the third region 20c, and reaches the tank lid 2 (the bottom of the recess 29). The inner terminal 10 and the external terminal 12 are exposed to the internal space 20 (the second region 20b and third region 20c) respectively from the bottoms of the recesses 28, 29.

A communication opening 22 is provided in a lateral wall of the recess 28 (the lateral part 6d defining the second region 20b). An opening size of the communication opening 22 on an internal space 20 side (second region 20b side) is smaller than a size of a portion of the lateral part 6d that defines the second region 20b. That is, the communication opening 22 is connected to a part of the second region 20b. The internal space 20 (the second region 20b) communicates with an external space of the accommodation unit 6 through the communication opening 22. Further, the communication opening 22 is provided below the boundary 20d. The communication opening 22 is provided at an intermediate portion of the second region 20b in the up-down direction. The waterproof film 24 covers an external space side of the communication opening 22. The waterproof film 24 is attached to the lateral part 6d. The waterproof film 24 has air permeability and waterproof property. As the waterproof film 24, a vent filter provided with a PTFE (polytetrafluoroethylene) porous film is used, for example. A protective plate 26 surrounds a periphery of the waterproof film 24 (see FIG. 4).

An advantage of the fuel tank lid unit 1 will be described. The inner terminal 10 penetrates the tank lid 2 and extends from within the fuel tank 50 to inside of the accommodation unit 6. Due to this, vaporized fuel within the fuel tank 50 might enter the accommodation unit 6 through an interface between the inner terminal 10 and the tank lid 2. Specific gravity of the vaporized fuel is higher than specific gravity of air. Due to this, the vaporized fuel that had entered the accommodation unit 6 accumulates in the second region 20b. Specifically, the vaporized fuel starts to accumulate from the bottom of the second region 20b. The vaporized fuel accumulating in the second region 20b is discharged to outside of the accommodation unit 6 from the communication opening 22 provided at the intermediate portion of the second region 20b. The vaporized fuel is suppressed from flowing into the first region 20a across the boundary 20d. The vaporized fuel that had entered the accommodation unit 6 is isolated in a limited range (the second region 20b) within the accommodation unit 6, thus the vaporized fuel can be prevented from coming into contact with the electronic circuit 8.

Another advantage of the fuel tank lid unit 1 will be described. As described above, the gap 70 is provided between the tank lid 2 and the bottom 6a of the accommodation unit 6. Due to this, the vaporized fuel that had flown through the tank lid 2 from the fuel tank 50 can be prevented from directly entering the accommodation unit 6. Further, the gap 70 extends from one end of the lateral part of the accommodation unit 6 to another end thereof, thus external air can flow through the gap 70. Due to this, the vaporized fuel is suppressed from accumulating in the gap 70, by which the vaporized fuel can further be suppressed from entering the accommodation unit 6. Further, since the external air can flow through the gap 70, a temperature rise in the accommodation unit 6 caused by heat generation of the electronic circuit 8 can be suppressed by the external air.

Further, since the inner terminal 10 passes the recess 28 (the second region 20b), a length of the inner terminal 10 exposed to the internal space 20 can be made long as compared to a case where the inner terminal 10 passes another part other than the recess 28, for example. By making the length of the inner terminal 10 long, even if a positional displacement occurs between a position of the inner terminal 10 and a position of a joining portion of the electronic circuit 8 when the inner terminal 10 is joined to the electronic circuit 8, the inner terminal 10 can deform, which can reduce force applied to the electronic circuit 8. Further, even if the electronic circuit 8 and the tank lid 2 expand differently during use (after the inner terminal 10 and the electronic circuit 8 have been joined together), the inner terminal 10 can deform, which can reduce force applied to the joining portion of the inner terminal 10 and the electronic circuit 8.

In the accommodation unit 6, the recess 29 is provided to configure the third region 20c, and the external terminal 12 extends from the electronic circuit 8, passes through the first region 20a and the third region 20c and reaches the bottom 6a. However, the recess 29 (the third region 20c) is not necessarily required. The external terminal 12 may extend from the electronic circuit 8, pass through the first region 20a and reach the bottom 6a, without the recess 29.

Further, a member configured to suppress transfer of the vaporized fuel may be arranged within the gap 70. The member configured to suppress transfer of the vaporized fuel may be a lamination of sheet-shaped materials (impermeable films). Alternatively, inside of the gap 70 may be filled by the same material (resin) as that of the tank lid 2. That is, the gap 70 may not be provided.

Hereinbelow, fuel tank lid units according to second to ninth embodiments will be described. The fuel tank lid units described hereinbelow are variants of the fuel tank lid unit 1 according to the first embodiment, and structures of their accommodation units are different from that of the accommodation unit 6 of the fuel tank lid unit 1. Due to this, for the second to ninth embodiments, only the structures of their accommodation units will be described. Each of the accommodation units according to the second to ninth embodiments may be used in the fuel tank lid unit 1 as a substitute to the accommodation unit 6 according to the first embodiment (also see FIGS. 1 and 2). Further, hereinbelow, different features from those of the accommodation unit 6 will be described, and common features with the accommodation unit 6 may be given the same reference signs as for the accommodation unit 6 and description for them may be omitted.

### Second Embodiment

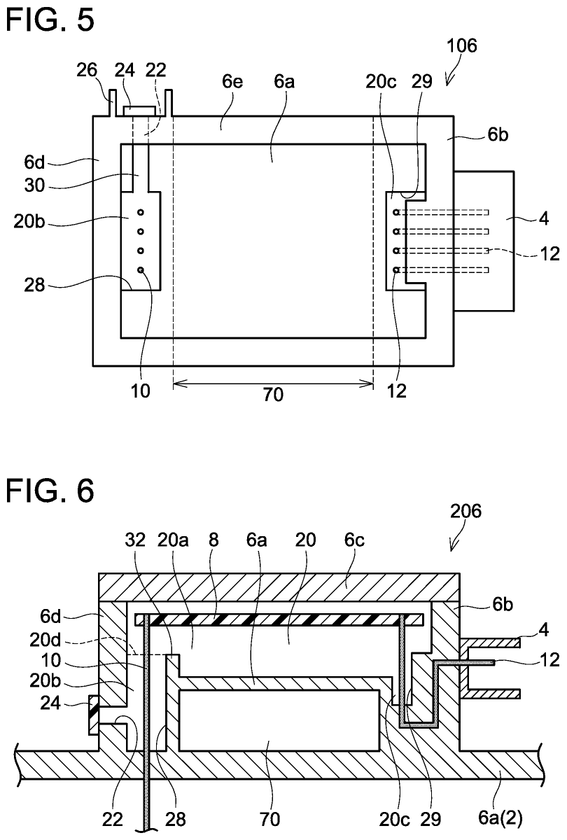

An accommodation unit 106 will be described with reference to FIG. 5. In the accommodation unit 106, the communication opening 22 is not provided in the lateral part 6d defining the second region 20b. The communication opening 22 is provided in a lateral part 6e connecting the lateral part 6b and the lateral part 6d. The lateral part 6e extends in a direction perpendicularly intersecting the lateral part 6b and the lateral part 6d. That is, the communication opening 22 is provided in the lateral part 6e in a direction along which the gap 70 extends. The communication opening 22 is provided below the boundary 20d. The communication opening 22 and the second region 20b are connected by a passage 30. The passage 30 is a recess provided in the bottom 6a of the accommodation unit 106. Vaporized fuel in the second region 20b flows from the second region 20b through the passage 30, and is discharged from the communication opening 22. Providing the passage 30 increases a degree of freedom for a position where the communication opening 22 is provided.

### Third Embodiment

An accommodation unit 206 will be described with reference to FIG. 6. The accommodation unit 206 is provided with a wall 32 extending upward from the bottom 6a. The wall 32 is provided along a shape of the recess 28. In other words, in a plan view of the accommodation unit 206, a shape of the wall 32 is identical with the shape of the recess 28. Due to this, the boundary 20d between the first region 20a and the second region 20b is an upper end of the wall 32. Providing the wall 32 can increase a depth of the second region 20b (that is, a volume of the second region 20b). Since a larger amount of vaporized fuel can be retained in the second region 20b than in the accommodation unit 6 (see FIG. 3 for comparison), the vaporized fuel can be prevented from flowing to a region (such as the first region 20a) other than the second region 20b even when the vaporized fuel entering the internal space 20 increases.

### Fourth Embodiment

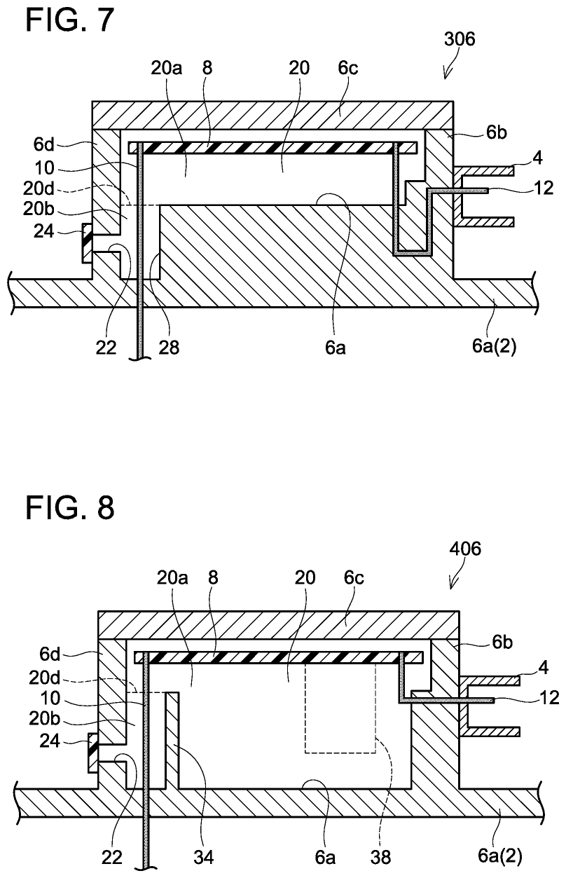

An accommodation unit 306 will be described with reference to FIG. 7. The accommodation unit 306 does not have the gap 70 provided between the bottom 6a and the tank lid 2 (see FIG. 3 for comparison). Further, the accommodation unit 306 also does not have the recess 29 provided therein. The effect of retaining vaporized fuel in the second region 20b can be achieved by providing the second region 20b below the first region 20a, even without the gap 70 and the recess 29.

### Fifth Embodiment

An accommodation unit 406 will be described with reference to FIG. 8. In the accommodation unit 406, the recesses 28, 29 are not provided in the bottom 6a (see FIG. 3 for comparison). The accommodation unit 406 is provided with a wall 34 extending upward from the bottom 6a. The wall 34 surrounds the inner terminal 10. In the accommodation unit 406, a range surrounded by the wall 34 and the lateral part 6d is the second region 20b. Due to this, the boundary 20d between the first region 20a and the second region 20b is an upper end of the wall 34. In a plan view of the accommodation unit 406, an area of the range surrounded by the wall 34 and the lateral part 6d (the second region 20b) is equal to that of the second region 20b of the accommodation unit 6 (see FIG. 4 for comparison). That is, in the plan view of the accommodation unit 406, the area of the second region 20b is smaller than an area of the first region 20a. The accommodation unit 406 is advantageous in a case where a large-size component (such as a component 38) is arranged on the electronic circuit 8. That is, the second region 20b for accumulating vaporized fuel can be provided in the accommodation unit 406 without increase in a size (a length in the up-down direction) of the accommodation unit 406.

### Sixth Embodiment

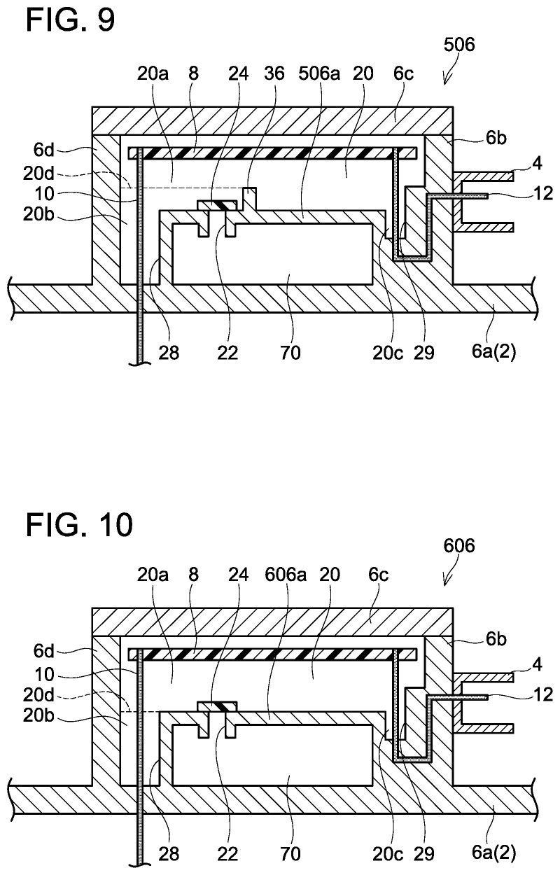

An accommodation unit 506 will be described with reference to FIG. 9. In the accommodation unit 506, a wall 36 extending upward is provided on a bottom 506a. The wall 36 surrounds the recess 28. In the accommodation unit 506, in addition to the recess 28, a region surrounded by the wall 36 on the bottom 506a also functions as the second region 20b. Further, in the accommodation unit 506, the communication opening 22 is provided in the bottom 506a that is within the range surrounded by the wall 36. That is, the communication opening 22 is provided within the second region 20b. Further, the waterproof film 24 closes the opening of the communication opening 22 on the internal space 20 side. Vaporized fuel in the second region 20b is discharged to the gap 70 between the bottom 506a and the tank lid 2. Since the communication opening 22 and the waterproof film 24 are not exposed at the lateral part in the accommodation unit 506, an outer shape of the accommodation unit can be simplified.

The accommodation units 106 to 506 described above all have a common feature that the communication opening 22 and the second region 20b are connected directly or via a passage. Due to this, vaporized fuel that had entered the internal space 20 does not flow to a region (such as the first region 20a) other than the second region 20b, and is discharged to outside of the accommodation unit from the second region 20b.

### Seventh Embodiment

An accommodation unit 606 will be described with reference to FIG. 10. In the accommodation unit 606, the communication opening 22 is provided in a bottom 606a. The communication opening 22 does not directly communicate with the second region 20b. Further, the waterproof film 24 is provided inside the accommodation unit 606, that is, on a surface of the bottom 606a. In the accommodation unit 606, the boundary 20d between the first region 20a and the second region 20b is the surface of the bottom 606a. The opening of the communication opening 22 on the internal space 20 side is at a same height as the boundary 20d, and the opening of the communication opening 22 on an external space side is below the boundary 20d. Due to this, in the accommodation unit 606, the communication opening 22 can be said as being provided below the boundary 20d. The opening of the communication opening 22 on the external space side faces the gap 70. Vaporized fuel having large specific gravity is discharged to outside of the accommodation unit 606 through the communication opening 22, and is discharged to outside of the fuel tank lid unit through the gap 70.

In the accommodation unit 606, the communication opening 22 does not communicate with the second region 20b. Due to this, vaporized fuel having entered the accommodation unit 606 accumulates in the second region 20b, and when it exceeds a capacity of the second region 20b, a part of the vaporized fuel that has flown over the upper end of the second region 20b (the boundary 20d) is discharged to the outside. Since the vaporized fuel flows to the communication opening 22 along the surface of the bottom 606a, the vaporized fuel can be prevented from flowing to an upper part of the first region 20a (to a position where the electronic circuit 8 is arranged).

### Eighth Embodiment

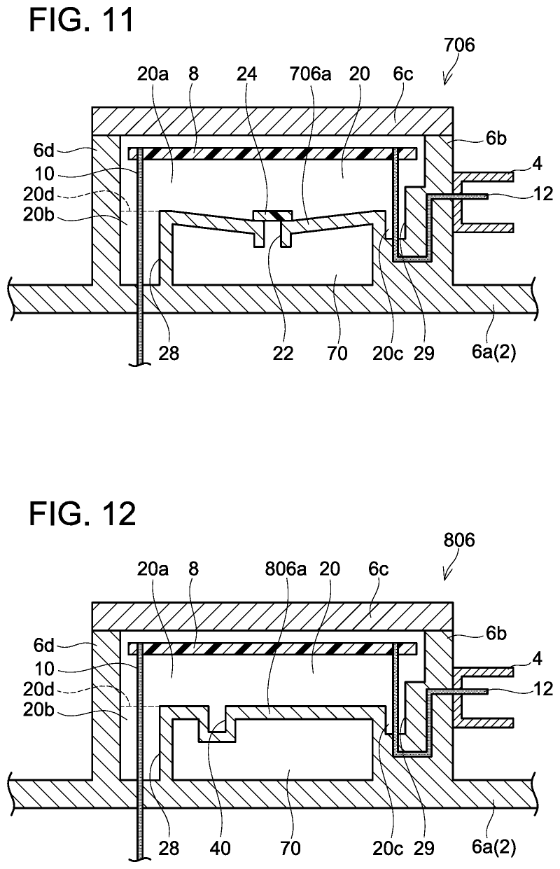

An accommodation unit 706 will be described with reference to FIG. 11. The accommodation unit 706 is a variant of the accommodation unit 606. In the accommodation unit 706, a bottom 706a is inclined downward toward the communication opening 22. Due to this, vaporized fuel that has flown over the boundary 20d can easily flow toward the communication opening 22. The vaporized fuel can be discharged to outside of the accommodation unit faster. In the accommodation unit 706, both the openings of the communication opening 22 on the internal space side and the external space side are located below the boundary 20d. In the accommodation unit 706 as well, the communication opening 22 is located below the boundary 20d.

### Ninth Embodiment

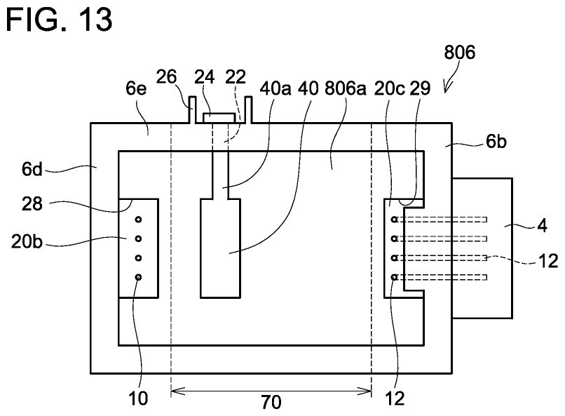

An accommodation unit 806 will be described with reference to FIGS. 12 and 13. In the accommodation unit 806, a recess 40 is provided between the recesses 28, 29. The recess 40 is provided at a position separated from the recesses 28, 29. A depth of the recess 40 is shallower than that of the recess 28. Further, the communication opening 22 is provided in the lateral part 6e. The communication opening 22 is provided above the opening of the gap 70. The recess 40 and the communication opening 22 are connected by a passage 40a. In the accommodation unit 806, vaporized fuel is discharged to outside of the fuel tank lid unit without being discharged into the gap 70.

In each of the above embodiments, the fuel tank lid unit in which the accommodation unit and the tank lid are integrated (formed integrally) has been described. However, the accommodation unit and the tank lid may be separate components. That is, the fuel tank lid unit may be configured by connecting the accommodation unit and tank lid, which are separate components. Further, the upper lid of the accommodation unit may be constituted of resin. In this case, the material of the upper lid may be the same resin as that of the lateral parts, or may be different resin from that of the lateral parts. What is important is to provide not only a space where the electronic circuit is arranged (the first region) but also a space for accumulating vaporized fuel below the first region (the second region) within the accommodation unit. Further, what is important is that wiring (the inner terminal) connecting the electronic circuit and the electronic component in the fuel tank passes within the second region (the inner terminal is surrounded by the second region).

While specific examples of the present disclosure have been described above in detail, these examples are merely illustrative and place no limitation on the scope of the patent claims. The technology described in the patent claims also encompasses various changes and modifications to the specific examples described above. The technical elements explained in the present description or drawings provide technical utility either independently or through various combinations. The present disclosure is not limited to the combinations described at the time the claims are filed. Further, the purpose of the examples illustrated by the present description or drawings is to satisfy multiple objectives simultaneously, and satisfying any one of those objectives gives technical utility to the present disclosure.

1. A fuel tank lid unit comprising:
a tank lid closing an opening at an upper part of a fuel tank;
an accommodation unit provided on the tank lid and having an electronic circuit accommodated in an internal space thereof; and
an inner terminal penetrating the tank lid and connecting the electronic circuit and an electronic component inside the fuel tank,
wherein
the accommodation unit comprises a communication opening communicating the internal space and an external space,
the internal space of the accommodation unit comprises a first region in which the electronic circuit is arranged and a second region provided below the first region and surrounding the inner terminal,
an area of the second region is smaller than an area of the first region in a plan view of the accommodation unit, and
the communication opening is provided below an end of the second region on a first region side, and
the inner terminal is exposed to the internal space of the accommodation unit at a bottom of the second region.

2. The fuel tank lid unit according to claim 1, wherein the second region is a recess extending from a part of a bottom of the accommodation unit toward the tank lid.

3. The fuel tank lid unit according to claim 1, wherein the second region is defined by a wall extending upward from a bottom of the accommodation unit.

4. The fuel tank lid unit according to claim 3, wherein the communication opening is provided in the second region.

5. The fuel tank lid unit according to claim 4, wherein a gap communicated with the external space is provided between a bottom of the accommodation unit and the tank lid.

6. The fuel tank lid unit according to claim 5, wherein an opening of the communication opening on an external space side faces the gap.

7. The fuel tank lid unit according to claim 6, wherein the tank lid and the accommodation unit are integrated.

8. The fuel tank lid unit according to claim 1, wherein the second region is defined by a wall extending upward from a bottom of the accommodation unit.

9. The fuel tank lid unit according to claim 1, wherein the communication opening is provided in the second region.

10. The fuel tank lid unit according to claim 1, wherein a gap communicated with the external space is provided between a bottom of the accommodation unit and the tank lid.

11. The fuel tank lid unit according to claim 10, wherein an opening of the communication opening on an external space side faces the gap.

12. The fuel tank lid unit according to claim 1, wherein the tank lid and the accommodation unit are integrated.
